(19) United States
(12) Patent Application Publication
(10) Pub. No.: US 2024/0302641 A1
(43) Pub. Date: Sep. 12, 2024

(54) CHROMATIC FOCUSING VIA FILTER THICKNESS TUNING

(71) Applicant: Bio-Rad Laboratories, Inc., Hercules, CA (US)

(72) Inventors: Evan THRUSH, San Anselmo, CA (US); Stephen SWIHART, Walnut Creek, CA (US)

(21) Appl. No.: 18/597,463

(22) Filed: Mar. 6, 2024

Related U.S. Application Data
(60) Provisional application No. 63/450,912, filed on Mar. 8, 2023.

(51) Int. Cl. G02B 21/36; G02B 21/08

(52) U.S. Cl. CPC G02B 21/361; G02B 21/086

(57) ABSTRACT

The present relates to chromatic focusing via filter thickness tuning. Chromatic focusing can be achieved via an imaging system that includes a sample holding plane, a light source that illuminates the sample on the plane, and an imager that captures an image of the sample on the plane. The imager includes a sensor, a lens, and a filter wheel defining a plurality of filter apertures including a first aperture containing a first filter passing light of a first color and having a first focal point shift, and a second aperture containing a second filter passing light of a second color and having a second focal point shift. The focal point shifts cause both light of the first color passing through the first filter and through the lens and light of the second color passing through the second filter and through the lens to focus on the sensor.

### CROSS REFERENCES TO RELATED APPLICATIONS

The present application claims priority to U.S. Provisional Patent Application No. 63/450,912 filed Mar. 8, 2023, the full disclosure of which is incorporated herein by reference in its entirety for all purposes.

### BACKGROUND

Sample analysis frequently uses imaging to detect the presence of a target and/or to quantify that target. This imaging is frequently done with different wavelengths of light. For example, an imager may include a plurality of channels each of which can correspond to a different wavelength and/or range of wavelengths of light. These different channels, also referred to herein as color channels, can thus each correspond to a color of light. Use of different color channels in imaging is beneficial, however, further improvements to imaging systems are desired.

### BRIEF SUMMARY

One aspect of the present disclosure relates to an imaging system. The imaging system includes a plane that can receive and hold a sample. The imaging system includes a light source oriented to illuminate the sample on the plane when the light source is activated, and an imager oriented to image a sample on the plane when an image is captured by the imager. The imager includes a sensor, a lens, and a filter wheel defining a plurality of filter apertures. The plurality of apertures include a first aperture containing a first filter having a first focal point shift and which first filter passes light having a first color, and a second aperture containing a second filter having a second focal point shift and which second filter passes light having a second color. In some embodiments, light of the first color passing through the first filter and through the lens is focused on the sensor. In some embodiments, light of the second color passing through the second filter and through the lens is focused on the sensor.

In some embodiments, the first filter has a first thickness and a first refractive index for light of the first color. In some embodiments, the second filter has a second thickness and a second refractive index for light of the second color. In some embodiments, the first thickness is the same as the second thickness. In some embodiments, the first refractive index is different than the second refractive index. In some embodiments, the first thickness is different than the second thickness. In some embodiments, the first refractive index is the same as the second refractive index.

In some embodiments, the first filter can be a first absorbance filter and a first dielectric filter. In some embodiments, the first thickness of the first filter can be a combined first absorbance filter thickness and first dielectric filter thickness. In some embodiments, the second thickness of the second filter can be a combined second absorbance filter thickness and second dielectric filter thickness. In some embodiments, the lens can be an achromatic lens.

In some embodiments, a position of the lens with respect to the sensor is fixed. In some embodiments, the filter wheel is positioned between the lens and the sensor such that light passing through the lens passes through the filter wheel before arriving at the sensor. In some embodiments, the lens is positioned between the filter wheel and the sensor such that light passing through the filter wheel passes through the lens before arriving at the sensor.

One aspect relates to a method of imaging. The method includes placing a sample on a plane, which plane can be imaged by an imager. In some embodiments, the imager can include a filter wheel defining a plurality of filter apertures. In some embodiments, the plurality of apertures can include a first aperture containing a first filter having a first focal point shift, which first filter passes light having a first color, and a second aperture containing a second filter having a second focal point shift, which second filter passes light having a second color. The imager can include a sensor, and a lens. The method can include positioning the first filter in an optical path from the plane through the lens and ending at the filter, generating a first image of first colored light passing through the first filter, positioning the second filter in the optical path, and generating a second image of second colored light passing through the second filter.

In some embodiments, the first filter has a first thickness and a first refractive index for light of the first color. In some embodiments, the second filter has a second thickness and a second refractive index for light of the second color. In some embodiments, the first thickness is the same as the second thickness. In some embodiments, the first refractive index is different than the second refractive index. In some embodiments, the first thickness is different than the second thickness. In some embodiments, the first refractive index is the same as the second refractive index.

In some embodiments, the first filter can include a first absorbance filter and a first dielectric filter. In some embodiments, the first thickness of the first filter can include a combined first absorbance filter thickness and first dielectric filter thickness. In some embodiments, the second thickness of the second filter can include a combined second absorbance filter thickness and second dielectric filter thickness.

In some embodiments, the lens can be an achromatic lens. In some embodiments, a position of the lens with respect to the sensor is fixed. In some embodiments, the filter wheel is positioned between the lens and the sensor such that light passing through the lens passes through the filter wheel before arriving at the sensor. In some embodiments, the lens is positioned between the filter wheel and the sensor such that light passing through the filter wheel passes through the lens before arriving at the sensor.

### BRIEF DESCRIPTION OF THE DRAWINGS

FIG. 1 is a schematic depiction of one embodiment of a system for chromatic focusing.

FIG. 2 is a side-perspective-section view of one embodiment of a system for chromatic focusing.

FIG. 3 is a perspective view of some of the components of the system for chromatic focusing.

FIG. 4 is a perspective view of one embodiment of a detector.

FIG. 5 is a front view of one embodiment of the filter wheel.

FIG. 6 is a back view of one embodiment of a filter wheel.

FIG. 7 is a side section view of one embodiment of the filter wheel.

FIG. 8 is a flowchart illustrating one embodiment of a process for chromatic focusing via filter thickness tuning.

### DETAILED DESCRIPTION

Sample analysis can be performed via numerous different techniques, including, for example, western blot. In some forms of analysis, a sample can be collected and prepared. The sample can then be separated via gel electrophoresis in a gel block. The sample can be transferred from the gel block to an analysis block. One or several images of the sample can then be generated with an imager. An imager can include a lens, a plurality of filters, and a sensor.

These images of the sample can be generated with light of different colors, more specifically, with light having different wavelengths. For example, a first image can be generated from light emitted from the sample having a first color, and more specifically having a first wavelength and/or falling in a first range of wavelengths, and a second image can be generated from light emitted from the sample having a second color, and more specifically having a second wavelength and/or falling in a second range of wavelengths. In some embodiments, an imager can have a plurality of color channels, and can generate images using some or all of these color channels.

The generation of images with different color channels of light can provide benefits in performing the analysis. For example, the use of multiple color channels can enable better identification of target in the sample, and/or can enable identification of different targets within the sample.

While these different color channels provide benefits, they also provide drawbacks. Specifically, Different wavelengths of light are refracted differently by a lens. Thus, while the lens may focus light of one wavelength on the sensor to thereby enable crisp imaging, another wavelength of light may not be so well focused on the sensor. This lack of focus of the other wavelength can impact the ability of the imager to generate a crisp and clear image. To some extent, the lens refracts light of each wavelength differently, and thus, the lens does not perfectly focus light on the sensor.

This different refraction of light of different wavelengths can be partially addressed with an achromatic lens. However, while the achromatic lens may mitigate some of these refractive differences based on wavelength of the refracted light, these refractive differences still exist. Further, in some embodiments, an achromatic lens can have a more complicated design and can be more expensive. Thus, an achromatic lens does not solve this problem of wavelength-based varying refraction by the lens.

Another potential solution is making the focus of the lens adjustable. This can include creating a mechanical structure configured to move the lens with respect to the sensor to ensure that proper focus is attained. However, such systems can be expensive, and can slow the generation of different images, and thus slow the analysis.

Some embodiments of the present disclosure relate to the use of an additional refractive element to match refraction of the lens to the wavelength of light presently being imaged. Thus, a first additional refractive element can be added to the optical path to image light of a first wavelength and/or of a first range of wavelengths, and a second additional refractive element can be added to the optical path to image light of a second wavelength and/or of a second range of wavelengths. Via use of these additional refractive elements, focused images can be easily generated. Further, these focused images can be generated without having focusing features on the imager, thus the relative position of the lens with respect to the sensor does not have to be adjusted for different wavelengths of light to achieve crisp focus.

In some embodiments, these additional refractive elements can be filters that can have a parameter configure to achieve the desired refraction. For example, light of the first color can be imaged via use of a first filter. The refractive index of this first filter and/or the thickness of this first filter can be matched with the lens such that light of the first color when passing to the sensor via the lens and the first filter is focused. Similarly, light of the second color can be imaged via use of a second filter. The refractive index of this second filter and/or the thickness of this second filter can be matched with the lens such that light of the second color when passing to the sensor via the lens and the second filter is focused. Thus, in some embodiments, tuning of different filter thicknesses can provide chromatic focusing.

In some embodiments, switching between filters is already part of imaging in the different color channels, and thus, utilizing the filters as an additional refractive element does not slow the imaging and/or the analysis.

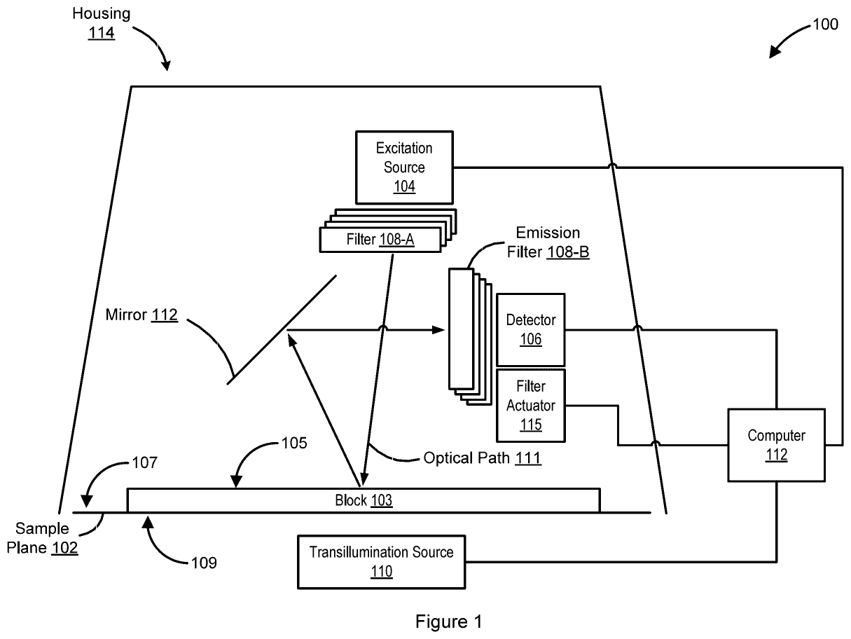

With reference now to FIG. 1, a schematic depiction of one embodiment of a system 100 for chromatic focusing is shown. The system 100 is configured for imaging of western blot membranes. The system 100 includes a plane 102, also referred to herein as a sample plane 102. The plane 102 can be configured to hold a sample. The plane 102 can be transparent or can be non-transparent. The plane can comprise a first side 107 and a second side 109. The plane 102 can comprise any desired size and shape, and in some embodiments, can be sized to receive and hold a block 103 comprising the sample. In some embodiments, the plane 102 is configured to receive and hold the block 103 on the first side 107 of the plane 102.

The block 103 can include any desired block including, for example, a gel block and/or an analysis block. As used herein, a “gel block” can be a substrate used in separating the proteins as a part of electrophoresis. The substrate can be made of a gel such as, for example, a polyacrylamide gel. In some embodiments, the gel block can be used as part of gel electrophoresis to separate the proteins of the sample. In some embodiments, the gel block can include a trihalo compound that, when bound with a protein, enhances the fluorescence of that protein. Specifically, the bonding of the trihalo compound with the protein shifts the fluorescent emission of the protein to a longer wavelength range that is more readily detectable. The bonding between the trihalo compound and the protein is a covalent bond. In some embodiments, the trihalo compound can be bonded to the protein in the gel black via illumination of the gel block, and specifically via illumination of the gel block with UV light. In some embodiments, this UV light can be generated by a light source, including, for example, the excitation source 104, the transillumination source 110, or any other light source.

As used herein, the “analysis block” can be substrate configured to hold the separated proteins after electrophoresis and during imaging. In some embodiments, the analysis block can be sized and shaped to be received by the sample plane 102 and to be imaged by the system 100. The analysis block can comprise a substrate that can be a membrane such as, for example, at least one of: a nitrocellulose membrane; and a polyvinylidene difluoride (PVDF) membrane. In some embodiments, the PVDF membrane can be a low-fluorescence PVDF (“LF PVDF”) membrane. In some embodiments, and as part of western blot imaging, the separated sample can be transferred to the analysis block subsequent to gel electrophoresis and before imaging. In some embodiments, these transferred proteins can already be bound to trihalo compound, and in some embodiments, the transferred proteins can be bound to trihalo compound after being transferred to the analysis block.

The analysis block 103 can immobilize the proteins that are transferred to the analysis block, and thus, the analysis block can be configured to stably hold the separated sample, and not interfere with the imaging of the separated sample. In some embodiments, the proteins of the sample are transferred to one side of the analysis block, and typically to a top 105 of the analysis block. In some embodiments, the top 105 of the analysis block can be the side of the analysis block that is relatively closest to a detector and/or imager. In some embodiments, the sample can be transferred to the top 105 of the analysis block to improve the ability of the detector and/or image to image light emitted from the sample, as, for example, light passing through the analysis block may be, to some degree, scattered.

The system 100 can further include an excitation source 104. The excitation source can be configured to generate excitation energy, and to direct that excitation energy towards the plane 102. When a block 103 is positioned on the plane 102, and is to be imaged, the excitation source 104 can generate excitation energy that energizes sample on the block 103, and specifically energizes fluorophores coupled to the sample on the block 103, thereby causing the fluorescing of those energized fluorophores.

The system 100 can include a detector 106, also referred to as an imager 106. The detector 106 can be configured to detect light emitted and/or reflected by sample on the block 103. Thus, in some embodiments, the detector 106 can be positioned and/or oriented to image a sample on the plane when an image is captured by the detector 106.

In some embodiments, the detector can comprise, for example, an imager, a camera, photodetector such as a photodiode or a phototransistor, or the like. In some embodiments, and as shown in FIG. 1, both the detector 106 and the excitation source 104 are positioned on the same side of the plane, or in other words, and as shown in FIG. 1, are both positioned above the plane 102, and specifically are positioned above the first side of the plane 102 such that the excitation source 104 is configured to illuminate the sample via epi-illumination. In some embodiments, the detector 106 and the excitation source 104 can be positioned on different sides of the plane 102, such that the excitation source 104 transilluminates sample through the second side 109 of the plane 102.

In some embodiments, the system 100 can include one or several excitation filters 108-A and/or one or several emission filters 108-B. In some embodiments, the one or several excitation filters 108-A can filter excitation energy, or in other words, can filter energy coming from the excitation source 104. In some embodiments, the one or several emission filters 108-B can filter emission energy, or in other words, can filter energy emitted from the block 103, or can filter undesired excitation light from parts in the system. In some embodiments, the one or several emission filters 108-B can be a part of the detector 106. In some embodiments, some or all of the one or several emission filters 108-B can be tuned for chromatic focusing, or in other words, can serve as additional refractive elements.

In some embodiments, the one or several emission filters 108-B can be controlled by a filter actuator 115. The filter actuator 115 can be configured to change the one or several emissions filters 108-B that is in the optical path 111. This can include, removing one emission filter 108-B from the optical path 111 and placing another emission filter 108-B in the optical path 111. In some embodiments, for example, when the system 100 is switching from imaging with one color channel to another color channel, the actuator 115 can remove the emission filter 108-B for the one color channel from the optical path 111 and can place the emission filter 108-B for another color channel in the optical path 11. In some embodiments, the actuator 115 can comprise a motor.

The one or several excitation filters 108-A and/or emission filters 108-B can be positioned along the optical path 111 between the plane 102 and one or both of the excitation source 104 and the detector 106. Thus, in some embodiments, light exits the excitation source 104, passes through one or several excitation filters 108-A, and impinges on the plane 102 and/or on the block 103 on the plane 102. In some embodiments, light from the plane 102 and/or from the block 103 on the plane 102 passes through the one or several emission filters 108-B and is received by the detector 106. In some embodiments, the excitation filters 108-A and/or emission filters 108-B can comprise any type of filter including, for example, a low-pass filter, a high-pass filter, a notch filter, a bandpass filter, an absorption glass, a color glass, a UV cut filter, a multi-band filter, and/or a tri-band filter. In some embodiments, the filters can be moveable with respect to the one of the excitation source 104 and the detector 106 with which the filter is associated such that an excitation filter 108-A and/or an emission filter 108-B can be positioned in the optical path of one or both of the excitation source 104 and the detector 106 to achieve a desired filtering.

In some embodiments, the system 100 can further include a transillumination source 110. The transillumination source 110 can be configured to illuminate the block 103 through the second side 109 of the plane 102. In some embodiments, the transillumination source 110 can comprise a source of visible illumination, a source of ultraviolet illumination, a source of infrared illumination, or the source of any other type of electromagnetic energy. The transillumination source 110 on a side of the plane 102 opposite the excitation source 104 and the detector 106, or in other words, the plane 102 can be positioned between the transillumination source 110 and both the excitation source 104 and the detector 106.

Each of the excitation source 104, the detector 106, the actuator 115, and the transillumination source 110 can be communicatively coupled to a computer 112. The computer 112 can be configured to control the system 100, and specifically to generate one or several control signals controlling operation of one or several components of the system 100, and to receive information from one or several components of the system 100. Thus, in some embodiments, the computer 112 can receive information from one or several of the excitation source 104, the detector 106, and the transillumination source 110, and can generate and send control signals to one or several of the excitation source 104, the detector 106, the actuator 115, and/or the transillumination source 110.

The computer 112 can, in some embodiments, be configured to provide information to a user and to receive inputs from a user. This can include, for example, providing information to a user via a user interface and/or receiving user inputs via the user interface. In some such embodiments, the computer 112 can include one or several hardware features configured to provide information to the user such as, for example, one or several screens, speakers, displays, or the like. In some embodiments, the computer can include one or several hardware features configured to receive user inputs such as, for example, one or several keyboards, keypads, mouses, microphones, cameras, or the like. In some embodiments, the computer 112 can be connected to another computing device, and the computer 112 can provide information to this other computing device and can receive user inputs from this other computing device.

The computer 112 can, in some embodiments, comprise one or several computing devices, which can include, for example, one or several personal computers, laptops, computing devices, tablets, smartphones, smart devices, or the like. In some embodiments, the computer can comprise at least a processor and memory. The memory can comprise stored instructions in the form of computer code, that when executed by the processor, cause the computer to take one or several actions. The memory can comprise primary and/or secondary memory. The memory can include, for example, cache memory, RAM, ROM, PROM, EPROM, EEPROM, one or several solid-state drives (SSD), one or several hard drives or hard disk drives, or the like. Thus, in some embodiments, the memory can include volatile and/or non-volatile memory.

The processor can include one or several microprocessors, such as one or several Central Processing Units (CPUs) and/or one or several Graphics Processing Units (GPUs). The processor can be a commercially available microprocessor from Intel®, Advanced Micro Devices, Inc.®, Nvidia Corporation®, or the like.

In some embodiments, the system 100 can include a mirror 112 and/or other reflective surface. The mirror 112 can be positioned in the optical path of the detector 106, and can be positioned to redirect light from the plane 102 to the detector 106 such that the detector 106 does not need to be positioned directly above the plane 102. In some embodiments, the inclusion of the mirror can improve flexibility in locating the detector 106 which can likewise facilitate in the positioning of the excitation source 104.

The system 100 can include housing 114 that can extend wholly or partially around the plane 102. In some embodiments, one or several components of the system 100 can be mounted to the housing 114. In some embodiments, the housing 114, together with the plane 102 can define an internal volume in which one or several components of the system 100 are contained. In some embodiments, for example, the excitation source 104, the detector 106, the filter(s) 108, and/or the mirror 112 can be located in, and/or mounted to the housing 114.

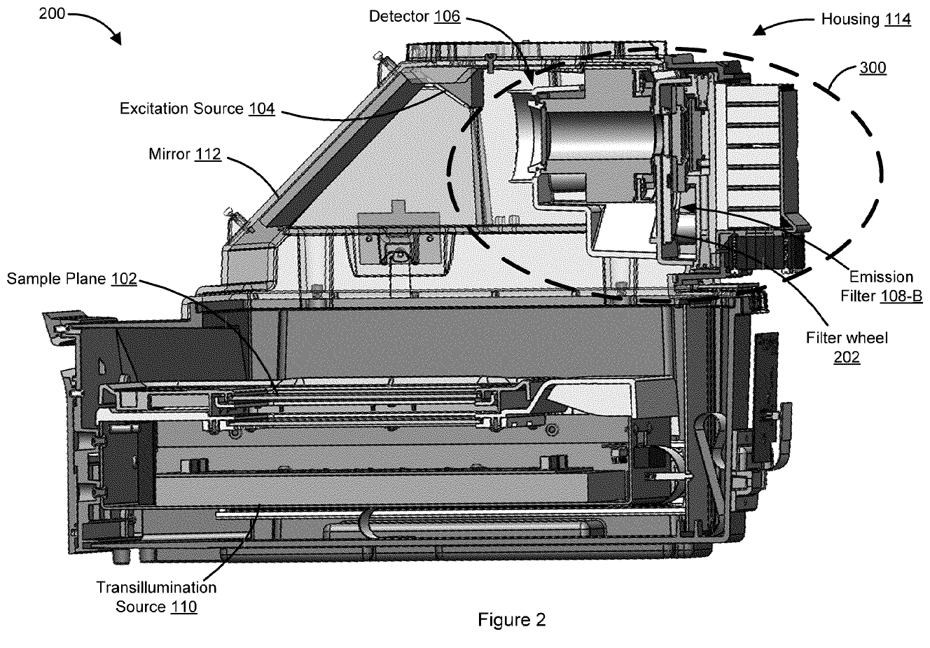

With reference now to FIG. 2, a side-perspective-section view of one embodiment of a system 200 is shown. The system 200 can be a specific configuration of the system 100 shown in FIG. 1, and thus can include some or all of the components and/or features of the system 100. As seen in FIG. 2, the system 200 includes a plane 102 and a housing 114. The housing 114 is positioned above the plane 102, and houses the excitation source 104, the mirror 112, and the detector 106. In some embodiments, the excitation filter 108-A can be incorporated into the excitation source 104. As seen in FIG. 2, the detector 106 includes the emission filter 108-B, which can comprise, for example, a filter wheel 202.

In some embodiments, the excitation source 104 is positioned and oriented with respect to the plane 102 so that the excitation source 104 illuminates all or portions of the plane 102, and in some embodiments, uniformly illuminates the plane 102.

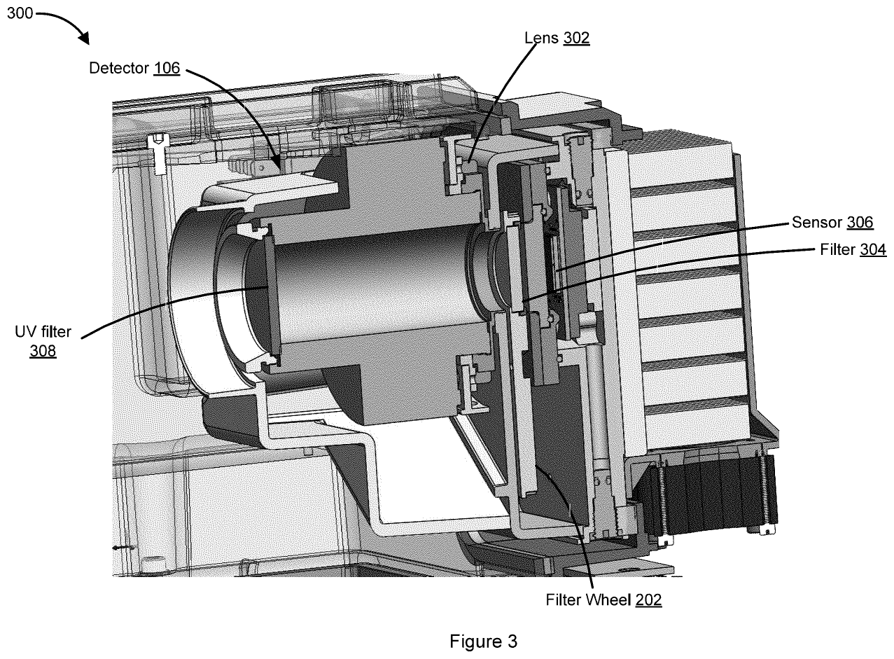

With reference now to FIG. 3, a perspective view of components in view 300 shown in FIG. 2 is shown. As seen, view 300 includes detector 106. The detector 106 can comprise a variety of shapes and sizes and can include a variety of components. In some embodiments, the detector 106 can include a lens 302, an emission filter 108-B which can comprise a filter wheel 202 containing a plurality of filters 304, and an image sensor 306, also referred to herein as sensor 306. The image sensor 306 can comprise, for example, a Sony CMOS or CCD image sensor such as, for example, ICX695, IMX183 or IMX178.

In some embodiments, the lens 302 can comprise an achromatic lens. In some embodiments, the lens 302 can comprise a unitary lens, and in some embodiments the lens 302 can comprise a lens assembly comprising a plurality of components which can include a plurality of optical components. In some embodiments in which the lens 302 comprises a compound lens, some or all of the plurality of components of the lens 302 can be fixed, and in some embodiments in which the lens 302 comprises a compound lens, some or all of the plurality of components of the lens can be moveable with respect to each other.

In some embodiments, the position of all or portions of the lens 302 with respect to the sensor 306 is fixed, and in some embodiments, the position of all or portions of the lens 302 with respect to the sensor 306 is variable. In some embodiments, the position of all or portions of the lens 302 with respect to the sensor 306 is fixed such that the focus of the imager 106 is fixed, and in some embodiments, the position of all or portions of the lens 302 with respect to the sensor 306 is variable such that the focus of the imager 106 is variable. Thus, in embodiments in which the lens 302 comprises a unitary lens, the position of the lens 302 can be fixed with respect to the sensor 306, or the position of the lens 302 can be variable with respect to the sensor. Similarly, in embodiments in which the lens 302 comprises a compound lens, the position of all or portions of the lens 302 can be fixed with respect to the sensor 306, or the position of all or portions of the lens 302 can be variable with respect to the sensor 306.

In some embodiment, the detector 106 can further include a UV filter 308, which can prevent excitation energy from reaching other components of the detector 106 to thereby prevent the glowing of those components such as, for example, the glowing of the lens 302. In some embodiments, the UV filter 308 can comprise a UV cut filter when the excitation source 104 comprises a UV excitation source, a multi-band filter, and/or a tri-band filter.

In some embodiments, and as depicted in FIG. 3, the filter wheel 202 is positioned between the lens 302 and the sensor 306 such that light passing through the lens 302 passes through the filter wheel 202 before arriving at the sensor 306. In other embodiments, the lens 302 is positioned between the filter wheel 202 and the sensor 306 such that light passing through the filter wheel 202 passes through the lens 302 before arriving at the sensor 306. In some embodiments, the positioning of the filter wheel 202 with respect to the lens 302 can beneficially decrease variability of filter thickness to achieve chromatic focusing via filter thickness tuning. Specifically, by positioning the filter wheel 202 between the lens 302 and the sensor 306, filter thicknesses and filter thickness variability to achieve chromatic focusing is less required if the lens 302 is positioned between the filter wheel 202 and the sensor 306.

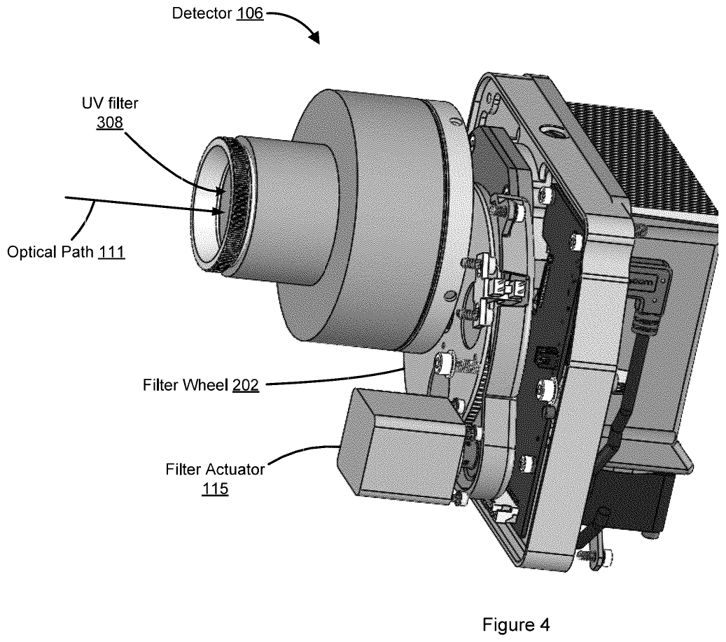

With reference now to FIG. 4, a perspective view of one embodiment of the detector 106 is shown. As seen, the detector 106 includes the filter wheel 202, which includes filters 304. As further seen, the filter wheel 202 is coupled with the filter actuator 115 such that the actuator 115 can control the relative position and/or orientation with respect to the optical path 111 into the detector 102.

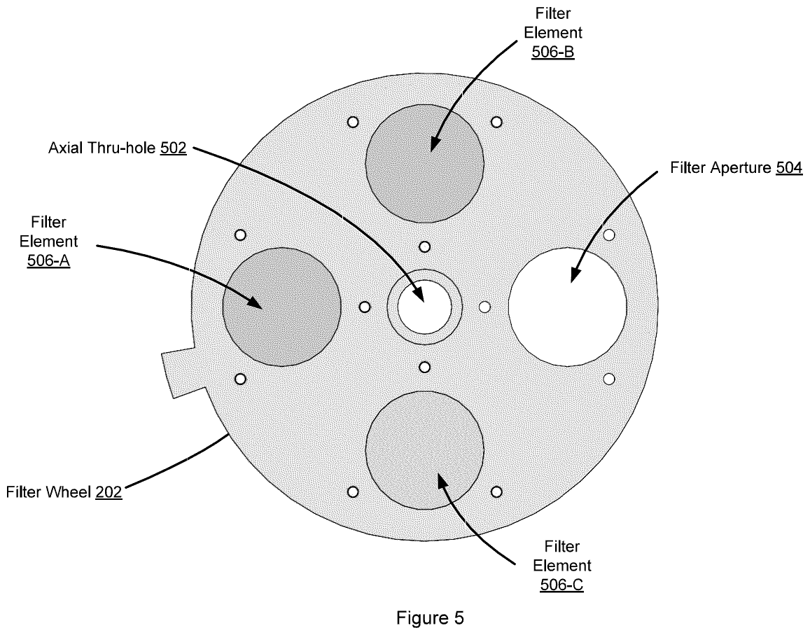

With reference now to FIG. 5, a front view of one embodiment of the filter wheel 202 is shown. The filter wheel 202 defines an axial thru-hole 502 about which the filter wheel 202 can rotate under control of the actuator 115. The filter wheel 202 further defines a plurality of filter aperture 504. Each of the filter apertures 504 can comprise a variety of shapes and sizes. In some embodiments, each of the filter apertures 504 can comprise a circular aperture extending completely through the filter wheel 202, in other words, in some embodiments, each of the apertures 504 can comprise a thru-hole.

In some embodiments, each of the filter apertures 504 can be configured to receive filter element 506. Thus, in some embodiments, a single filter wheel 202 can comprise a plurality of filter apertures 504 and can comprise a plurality of filter elements 506, each of which filter elements 506 can be located in a unique one of filter apertures 504. In some embodiments, each of the filter elements 506 can be configured to filter certain wavelengths of light and/or to pass certain wavelengths of light. In some embodiments, some or all of the filter elements 506 can filter different wavelengths of light and/or pass different wavelengths of light. Thus, in some embodiments, the filter elements 506 can comprise a first filter element 506-A that can filter and/or pass light of a first wavelength and/or of a first range of wavelengths, a second filter element 506-B that can filter and/or pass light of a second wavelength and/or of a second range of wavelengths, and a third filter element 506-C that can filter and/or pass light of a third wavelength and/or of a third range of wavelengths. Thus, in some embodiments, the first filter element 506-A can pass light of a first color, the second filter element 506-B can pass light of a second color, and the third filter element 506-C can pass light of a third color.

In some embodiments, each filter element 506 can comprise an addition refractive element, that together with the lens can focus light on the sensor 306. In some embodiments, each filter element 506 can cause a different focal point shift. Thus, a first filter element 506-A can have a first focal point shift, a second filter element 506-B can have a second focal point shift, and a third filter element 506-C can have a third focal point shift. In some embodiments, and the combination of each filter element 506 and the lens focuses light of the color passing through that filter element 506 on the sensor 306.

The filter elements 506 can comprise and desired number of different elements, each of which different elements can, in some embodiments, correspond to a unique color channel of the system 100. In some embodiments, the filter elements 506 can comprise 1 unique filter element, 2 unique filter elements, 3 unique filter elements, 4 unique filter elements, 5 unique filter elements, 6 unique filter elements, 10 unique filter elements 20 unique filter elements, or any other or intermediate number of filter elements.

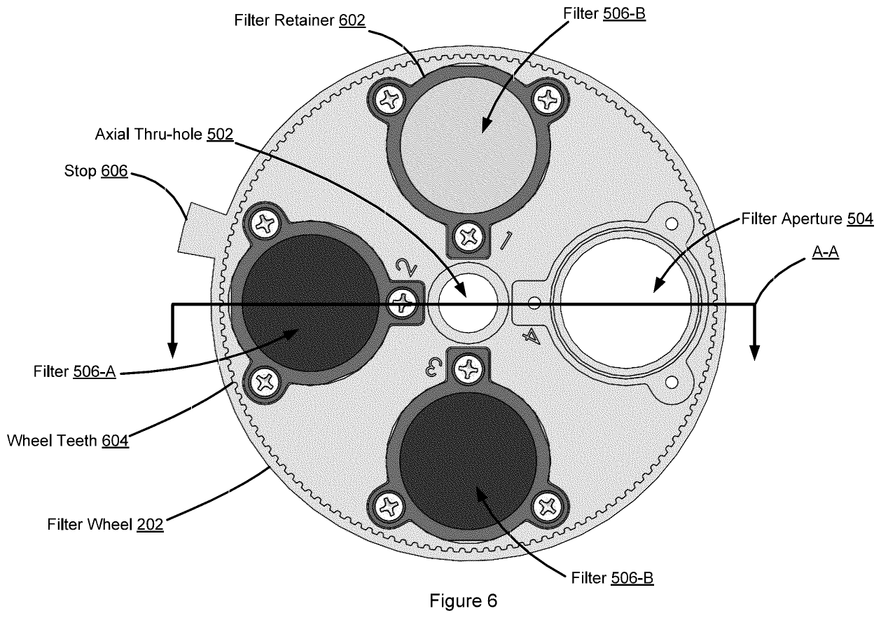

With reference now to FIG. 6, a back view of one embodiment of the filter wheel 202 is shown. As seen, the filter elements 506 are each held in place by a filter retainer 602. The filter retainer 602 can comprise a variety of shapes and sizes. In some embodiments, the filter retainer 602 can be configured to be coupled to the filter wheel 202 to secure one or several filter elements 506 in one or several filter apertures 504. In the embodiment shown in FIG. 6, each filter element 506 is secured in its respective filter aperture 504 by a unique filter retainer 602, which filter retainer 602 is coupled to the filter wheel 202 by one or several mechanical fasteners, and specifically by a plurality of threaded fasteners.

As further depicted in FIG. 6, the filter wheel 202 includes wheel teeth 604 extending around the circumference of the filter wheel 202. The filter teeth 604 are configured to matingly engage with the actuator 115. In some embodiments, the filter teeth 604 can be configured to mating engage directly or indirectly with a gear coupled to the actuator 115, and specifically coupled to a driveshaft of the actuator 115, such that rotation of the drive shaft causes the filter wheel 202 to rotate. In some embodiments, the filter wheel 202 can further include a stop 606 which can, in some embodiments, protrude from the exterior circumference of the filter wheel 202. The stop 606 can be configured to enable indexing of the location of the filter wheel 202 and to prevent the over-rotation of the filter wheel 202.

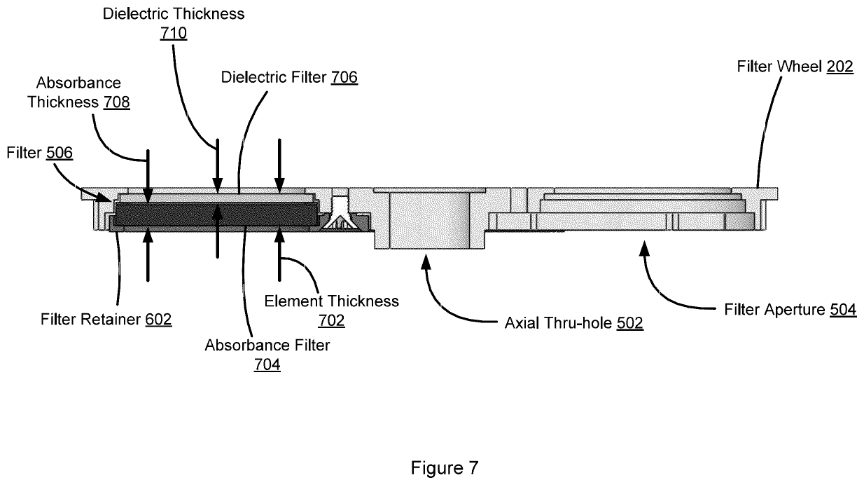

With reference now to FIG. 7, a side section view of the filter wheel 202 taken along cutting plane A-A depicted in FIG. 6 is shown. As seen, a filter element 506 is held in the filter aperture 504 of the filter wheel 202 by the filter retainer 602. The filter element 506 has an element thickness 702, also referred to herein as a filter thickness 702. In some embodiment, the element thickness 702 can be adjusted to achieve the desired refraction by the filter element 506. Thus, in some embodiments, an element thickness 702 of a first filter element 506 for filtering a first wavelength or range of wavelengths can be a first thickness, and an element thickness 702 of a second filter element 506 for filtering a second wavelength or range of wavelengths can be a second thickness. In some embodiments, each element thickness 702 can be selected to achieve a desired focus and/or a desired refraction, such that when the filter element 506 for a color channel is added to the optical pathway 111, the combination of the filter element 506 and the lens focuses light in the optical path 111 on the sensor 306.

In some embodiments, and as shown in FIG. 7, the filter element 506 can comprise a plurality of components including, for example, an absorbance filter 704 and a dielectric filter 706. In some embodiments, the absorbance filter 704 can be configured to absorb light other than the wavelength and/or range of wavelengths passed by the filter element 506. Thus, in some embodiments, the absorbance filter 704 can be configured to absorb all light other than light of the color imaged by the color channel of the system 100. The absorbance filter 704 can comprise an absorbance thickness 708.

The dielectric filter 706 can comprise a filter configured to restrict transmission of light not having a specific wavelength and/or not falling in a specific range of wavelengths. In some embodiments, the dielectric filter 706, can comprise a thin-film based filter. In some embodiments, the dielectric filter 706 can have a dielectric thickness 710.

In some embodiments, the element thickness 702 can be determined by the combination of the absorbance thickness 708 and the dielectric thickness 710. Thus, in some embodiments, the element thickness 702 can be effect by changing one or both of the absorbance thickness 708 and the dielectric thickness 710. Thus, in some embodiments, one or both of the absorbance thickness 708 and the dielectric thickness 710 of a first filter element 506 can be different than absorbance thickness 708 and the dielectric thickness 710 of a second filter element 506.

In some embodiments, different filter elements 506 can have different refractive indices. Thus, for example, a first filter element 506-A can have a first refractive index, a second filter element 506-B can have a second refractive index, and a third filter element 506-C can have a third refractive index. In some embodiments, some or all of the filter elements 506 can have different focal point shifts due to, for example, differences in one or both of their element thicknesses and/or their refractive indices. Thus, in some embodiments, a first filter element 506-A has a first thickness and a first refractive index for light of the first color, and/or in some embodiments, a second filter element 506-B has a second thickness and a second refractive index for light of the second color. In some embodiments, the first thickness is the same as the second thickness, and in some embodiments, the first refractive index is different than the second refractive index. In some embodiments, the first thickness is different than the second thickness, and the first refractive index is the same as the second refractive index. In some embodiments, due to the combination of the thickness and the refractive index of a given filter, that filter can shift the focal point of light passing through it.

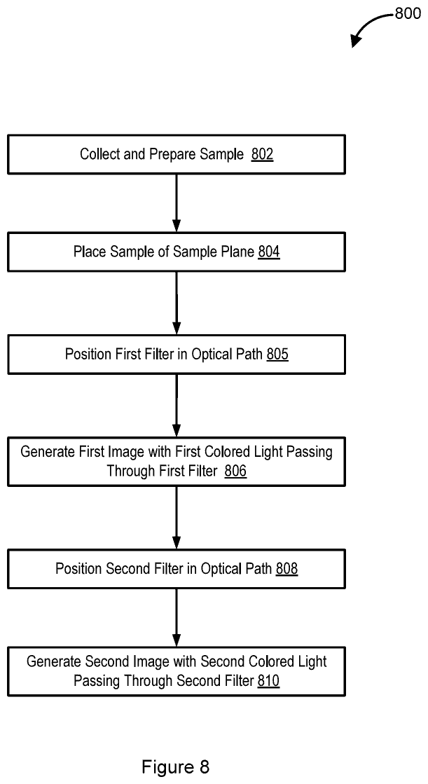

With reference now to FIG. 8, a flowchart illustrating one embodiment of a process 800 for chromatic focusing via use of filter thickness tuning is shown. The process 800 can be performed by all or portions of system 100 described above. The process 800 begins at step 802, wherein a sample is collected and prepared. In some embodiments, the sample can include target which can include, for example, one or several proteins. Thus, in some embodiments, the sample includes at least one protein.

At step 804, the sample is placed on the plane 102. In some embodiments, the sample can be placed directly on the plane 102, and in some embodiments, the sample can be loaded on a block 103 which block can be placed on the plane 102.

At step 805, a first filter element in positioned in the optical path 111. In some embodiments, this can include the computer 112 determining a position of the filter wheel 202 such as, for example, indexing the location of the filter wheel based on the stop 606. After having determined the location of the filter wheel 202, the computer 112 can determine a desired position of the filter wheel 202 for imaging with a desired color channel. The computer 112 can generate one or several control signals to cause the actuator 115 to move the filter wheel 202 to a position such that the first filter element 506-A is positioned in the optical path 111.

At step 806, a first image is generated with first colored light passing through the first filter element 506-A. In some embodiments, this is generating a first image via the first color channel. In some embodiments, the generation of the first image can include the computer 112 generating control signals to control operation of the excitation source 104 to illuminate the sample with excitation light, and generating control signals to control operation of the sensor 306 to generate one or several images comprising the first image. In some embodiments, the first image can be stored in, for example, memory associated with the computer 112.

At step 808, a second filter element 506-B in positioned in the optical path 111. In some embodiments, this can include the computer 112 determining a position of the filter wheel 202 such as, for example, indexing the location of the filter wheel based on the stop 606. Alternatively, in some embodiments, determining the location can include the computer 112 remembering the position of the filter wheel 202 from having just controlled to filter wheel 202 to position the first filter element 506-A in the optical path 111. After having determined the location of the filter wheel 202, the computer 112 can determine a desired position of the filter wheel 202 for imaging with a desired color channel. The computer 112 can generate one or several control signals to cause the actuator 115 to move the filter wheel 202 to a position such that the second filter element 506-B is positioned in the optical path 111. In some embodiments, moving the filter wheel 202 such that the second filter element 506-B is in the optical path 111 removes the first filter element 506-A from the optical path 111.

At step 810, a second image is generated with second colored light passing through the second filter element 506-B. In some embodiments, this is generating a second image via the second color channel. In some embodiments, the generation of the second image can include the computer 112 generating control signals to control operation of the excitation source 104 to illuminate the sample with excitation light, and generating control signals to control operation of the sensor 306 to generate one or several images comprising the second image. In some embodiments, the second image can be stored in, for example, memory associated with the computer 112. In some embodiments, via use of the first and second filter elements 506-A, 506-B, each having a thickness tuned to, in combination with the lens 302, filter light passed through the respective filter element 506-A, 506-B on the sensor 306, chromatic focusing can be achieved.

This description should not be interpreted as implying any particular order or arrangement among or between various steps or elements except when the order of individual steps or arrangement of elements is explicitly described. Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. An imaging system comprising:
a plane configured to receive and hold a sample;
a light source oriented to illuminate the sample on the plane when the light source is activated; and
an imager oriented to image a sample on the plane when an image is captured by the imager, the imager comprising:
a sensor;
a lens; and
a filter wheel defining a plurality of filter apertures, the plurality of apertures comprising:
a first aperture containing a first filter having a first focal point shift and configured to pass light having a first color; and
a second aperture containing a second filter having a second focal point shift and configured to pass light having a second color,
wherein light of the first color passing through the first filter and through the lens is focused on the sensor, and wherein light of the second color passing through the second filter and through the lens is focused on the sensor.

2. The imaging system of claim 1, wherein the first filter has a first thickness and a first refractive index for light of the first color, and wherein the second filter has a second thickness and a second refractive index for light of the second color.

3. (canceled)

4. The imaging system of claim 2, wherein the first thickness is the same as the second thickness, and wherein the first refractive index is different than the second refractive index.

5. (canceled)

6. The imaging system of claim 2, wherein the first thickness is different than the second thickness, and wherein the first refractive index is the same as the second refractive index.

7. (canceled)

8. The imaging system of claim 6, wherein the first filter comprises: a first absorbance filter; and a first dielectric filter.

9. The imaging system of claim 8, wherein the first thickness of the first filter comprises a combined first absorbance filter thickness and first dielectric filter thickness, and wherein the second thickness of the second filter comprises a combined second absorbance filter thickness and second dielectric filter thickness.

10. (canceled)

11. The imaging system of claim 9, wherein the lens comprises an achromatic lens.

12. The imaging system of claim 9, wherein a position of the lens with respect to the sensor is fixed.

13. The imaging system of claim 9, wherein the filter wheel is positioned between the lens and the sensor such that light passing through the lens passes through the filter wheel before arriving at the sensor.

14. The imaging system of claim 9, wherein the lens is positioned between the filter wheel and the sensor such that light passing through the filter wheel passes through the lens before arriving at the sensor.

15. A method of imaging comprising:
placing a sample on a plane, wherein the plane is configured to be imaged by an imager, the imager comprising:
a filter wheel defining a plurality of filter apertures, the plurality of apertures comprising:
a first aperture containing a first filter having a first focal point shift and configured to pass light having a first color; and
a second aperture containing a second filter having a second focal point shift and configured to pass light having a second color,
a sensor; and
a lens;
positioning the first filter in an optical path from the plane through the lens and ending at the filter;
generating a first image of first colored light passing through the first filter;
positioning the second filter in the optical path; and
generating a second image of second colored light passing through the second filter.

16. The method of claim 15, wherein the first filter has a first thickness and a first refractive index for light of the first color, and wherein the second filter has a second thickness and a second refractive index for light of the second color.

17. (canceled)

18. The method of claim 16, wherein the first thickness is the same as the second thickness, and wherein the first refractive index is different than the second refractive index.

19. (canceled)

20. The method of claim 16, wherein the first thickness is different than the second thickness, and wherein the first refractive index is the same as the second refractive index.

21. (canceled)

22. The method of claim 20, wherein the first filter comprises: a first absorbance filter; and a first dielectric filter.

23. The method of claim 22, wherein the first thickness of the first filter comprises a combined first absorbance filter thickness and first dielectric filter thickness, and wherein the second thickness of the second filter comprises a combined second absorbance filter thickness and second dielectric filter thickness.

24. (canceled)

25. The method of claim 23, wherein the lens comprises an achromatic lens.

26. The method of claim 23, wherein a position of the lens with respect to the sensor is fixed.

27. The method of claim 23, wherein the filter wheel is positioned between the lens and the sensor such that light passing through the lens passes through the filter wheel before arriving at the sensor.

28. The method of claim 23, wherein the lens is positioned between the filter wheel and the sensor such that light passing through the filter wheel passes through the lens before arriving at the sensor.
